(19) United States
(12) Patent Application Publication
(10) Pub. No.: US 2026/0121062 A1
(43) Pub. Date: Apr. 30, 2026

(54) COMPOSITE CATHODE MATERIAL COMPRISING CERAMIC OXIDE ELECTROLYTE, LITHIUM ELECTRODE MATERIAL AND ENHANCING AGENT

(71) Applicants: Umicore, Brussels (BE); FUNDACIÓN CENTRO DE INVESTIGACIÓN COOPERATIVA DE ENERGÍAS ALTERNATIVAS CIC ENERGIGUNE FUNDAZIOA, Vitoria-Gasteiz (ES)

(72) Inventors: Florencia MARCHINI, Brussles (BE); Travis THOMPSON, Brussels (BE); Sona VALIYAVEETTIL, Vitoria-Gasteiz (ES); Montserrat CASAS-CABANAS, Vitoria-Gasteiz (ES); Frederic AGUESSE, Vitoria-Gasteiz (ES)

(21) Appl. No.: 18/876,930

(22) PCT Filed: Jun. 27, 2023
(86) PCT No.: PCT/EP2023/067360

§ 371 Date: Dec. 19, 2024

(30) Foreign Application Priority Data
Jun. 27, 2022 (EP) 22382602.5

(51) Int. Cl. H01M 4/62; H01M 4/131

(52) U.S. Cl. CPC H01M 4/628; H01M 4/131; H01M 4/625

(57) ABSTRACT

The present invention relates to a solid composite cathode material comprising a ceramic oxide electrolyte material and a lithium electrode material. It was found that the addition of lithium halide to the selected electrolyte and cathode materials strongly enhances the electrochemical performance.

### TECHNICAL FIELD AND BACKGROUND

The present invention relates to a solid composite cathode material comprising a ceramic oxide electrolyte material and a lithium electrode material. The present invention further relates to methods to prepare said solid materials, to electrochemical cells such as solid-state batteries comprising said solid materials and to uses of the solid material in electrochemical cells such as solid-state batteries, in particular as a composite cathode material.

The three primary functional components of a lithium-ion battery are the anode, the cathode, and the electrolyte. While many variations exist, the anode of a conventional lithium-ion cell is typically made from carbon or metallic lithium, the cathode is typically made from transition metal oxides (in particular oxides of cobalt, nickel and/or manganese), and the electrolyte is typically a non-aqueous solvent containing a lithium salt. For example, mixtures of organic carbonates with lithium hexafluorophosphate are well known liquid electrolytes for lithium-ion batteries.

A significant disadvantage of liquid electrolytes is that the compositions, in particular the solvents are inflammable, which poses a large safety risk during normal operation and in particular in case of an incident. Another disadvantage is inherent to the liquid nature of the electrolyte, associated with risks of leakage and with increased risk of environmental pollution in case of a spill or leakage.

Recently, efforts have been made to develop solid electrolytes which allow the provision of a solid-state lithium-ion battery. Such solid-state batteries have significantly reduced EHS (environmental, health and safety) hazards. The solid-state electrolyte can act as an electrolyte as well as a separator, physically separating the anode and cathode material in order to prevent short-circuiting.

Without liquid fluidity, it is challenging to obtain intimate contact between solid electrolyte and electrode. The periodic electrode expanding and shrinking during cycle further deteriorates the mechanical particle-to-particle contact. As a consequence, high polarization, and low utilization of active materials are conventional in solid-state lithium batteries. An important key to realize solid-state lithium batteries with competitive performance thus relies on the construction of a stable and intimate interface between electrode and electrolyte. Direct co-sintering of electrode and electrolyte is used as a simple method to obtain good interfacial contact. However, the necessary high-temperature handling (>600° C.) facilitates ion interdiffusion across the interface, leading to side reactions between the electrode and solid electrolyte which, depending on the materials being sintered, can be detrimental to electrochemical performance. It has been suggested in the art to mitigate this problem by coating the cathode material with a buffer layer such as Nb, LiNbO₂, BaTiO₃ before sintering.

US2021/0083249A1 discloses coating of LLZO particles with lithium carbonate layers with addition of 2 wt. % lithium fluoride followed by sintering at 900° C. or higher.

It is an object of the present invention to provide improved composite cathode materials, in particular composite cathode materials having improved electrochemical performance such as improved cycling performance. It is a further object of the present invention to provide composite cathode materials which can be sintered at low temperatures.

### SUMMARY OF THE INVENTION

The present inventors have found that one or more objects of the invention can be achieved by the provision of a composite cathode material comprising lithium aluminium titanium phosphate (LATP) and/or lithium aluminium germanium phosphate (LAGP) electrolyte material, lithium nickel-manganese/cobalt oxide (e.g. NMC) cathode material and a lithium halide. As will be shown in the appended examples, it was found that the addition of lithium halide to the selected electrolyte and cathode materials strongly enhances the electrochemical performance (in particular the cycling performance) even without sintering the composite cathode material. It was further found that the addition of lithium halide to the selected electrolyte and cathode materials allows co-sintering of these materials at extremely low temperatures, surprisingly resulting in a sintered composite cathode material with limited degradation of LATP/LAGP or cathode material. Worded differently, the thermal stability of the composite cathode material is increased thereby reaching temperatures for sintering without decomposition of the composite cathode material. It was furthermore found that the enhanced electrochemical performance provided by the lithium halide addition is present even after sintering. As is shown herein, the addition of lithium halide in the context of the present invention was found to enhance the thermal stability of the composite cathode.

Accordingly, in a first aspect of the invention there is provided a solid composite cathode composition comprising:
a ceramic oxide electrolyte material comprising lithium aluminium titanium phosphate (LATP) and/or lithium aluminium germanium phosphate (LAGP);
an electrode active material comprising Li, M, and O, wherein M comprises Ni and one or both of Mn and Co; and
an enhancing agent which is Lix wherein X is a halide.

In another aspect of the invention there is provided a method for preparing a composite cathode comprising the steps of:
a) providing at least the following precursors:
   a ceramic oxide electrolyte material comprising lithium aluminium titanium phosphate (LATP) and/or lithium aluminium germanium phosphate (LAGP);
   an electrode active material comprising Li, M, and O, wherein M comprises Ni and one or both of Mn and Co;
   an enhancing agent which is LiX wherein X is a halide; and
   optionally a carbon-based conductivity aid;
b) preparing a substantially homogenous mixture comprising the precursors provided in step (a); and
c) optionally subjecting the mixture of step (b) to sintering.

In another aspect of the invention, there is provided an electrode comprising the solid composite cathode material as described herein in combination with a binder, such as a polymer binder.

In another aspect of the invention, there is provided an electrochemical cell comprising the solid composite cathode material as described herein.

In another aspect of the invention, there is provided the use of the solid composite cathode material as described herein as a cathode for an electrochemical cell.

In another aspect of the invention, there is provided a battery, more specifically a lithium-ion battery or a lithium metal battery comprising at least one electrochemical cell comprising the solid composite cathode material as described herein, for example two or more electrochemical cells according to the invention.

In another aspect of the invention, there is provided a method of making or operating cars, computers, personal digital assistants, mobile telephones, watches, camcorders, digital cameras, thermometers, calculators, laptop BIOS, communication equipment, remote car locks, and stationary applications such as energy storage devices for power plants by employing at least one battery or at least one electrochemical cell comprising the solid composite cathode material as described herein.

In another aspect of the invention, there is provided the use of the electrochemical cell comprising the solid composite cathode material of the invention in motor vehicles, bicycles operated by electric motor, robots, aircraft (for example unmanned aerial vehicles including drones), ships, satellites or stationary energy stores.

In another aspect of the invention, there is provided the use of lithium halide for improving the electrochemical properties, such as the cycling performance, of an electrochemical cell comprising a composite cathode material, said composite cathode material comprising lithium aluminium titanium phosphate (LATP) and/or lithium aluminium germanium phosphate (LAGP) electrolyte material and lithium nickel-manganese-cobalt oxide (NMC) cathode material.

### BRIEF DESCRIPTION OF THE FIGURES

FIG. 1 shows the temperature-dependent degradation of NMC-LATP mixtures as evidenced by the XRD spectrum of comparative examples 1, 2 and 4.

FIG. 2 shows the temperature-dependent deterioration of cycling performance of NMC-LATP mixtures of comparative examples 1-3.

FIG. 3 shows the enhancing effect of lithium fluoride addition on the electrochemical performance of the composite cathode materials of examples 5-7 as compared to comparative example 1.

FIG. 4 shows the enhancing effect of lithium fluoride addition on the electrochemical performance of the composite cathode materials of examples 8-10 as compared to comparative example 2.

### DETAILED DESCRIPTION

In the following detailed description, preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

The expression “composite cathode material” and “composite cathode composition” are used interchangeably throughout this document.

The expression “sintering” as used in the present application refers to the process of treating a solid material by heat and/or pressure without melting it to the point of liquefaction.

In a first aspect of the invention there is provided a solid composite cathode composition comprising:
a ceramic oxide electrolyte material comprising lithium aluminium titanium phosphate (LATP) and/or lithium aluminium germanium phosphate (LAGP);
an electrode active material comprising Li, M, and O, wherein M comprises Ni and one or both of Mn and Co; and
an enhancing agent which is LiX wherein X is a halide.

The solid composition of the invention is preferably a substantially homogenous mixture. In particular embodiments of the invention, the solid composition is a substantially homogenous mixture comprising optionally sintered discrete particles of the ceramic oxide electrolyte material, the electrode active material and the lithium halide. Such a solid comprising optionally sintered discrete particles of the ceramic oxide electrolyte material, the electrode active material and the lithium halide is obtainable by simply dry blending solid particles of the ceramic oxide electrolyte material, the electrode active material and the lithium halide followed by optionally sintering the mixture. It will be understood by the skilled person that while sintering will cause tight solid-solid interfaces or even merging of ceramic grains, the resulting solid is still substantially different from a solid wherein one of the compounds is coated on one of the other compounds. In some embodiments of the invention, at least the enhancing agent is distributed substantially homogenously throughout the composition.

The lithium aluminium germanium phosphate (LAGP) referred to herein is preferably LAGP of formula Li₁₊ₙAlₙGeₙ (PO₄)ₙ wherein 0<n<1, preferably wherein 0.2<n<0.8, more preferably wherein 0.3<n<0.5. According to the invention, n as referred to herein, is measured by Scanning Electron Microscopy with Energy Dispersive X-Ray (SEM-EDX) analysis.

The lithium aluminium titanium phosphate (LATP) referred to herein is preferably LATP of formula Li₁₊ₘAlₘTi₂₋ₘ (PO₄)₃ wherein 0<m<1, preferably wherein 0.2<m<0.8, more preferably wherein 0.3<m<0.5. According to the invention, m as referred to herein, is measured by Scanning Electron Microscopy with Energy Dispersive X-Ray (SEM-EDX) analysis.

The ceramic oxide electrolyte material preferably comprises lithium aluminium titanium phosphate (LATP), more preferably LATP of formula Li₁₊ₘAlₘTi₂₋ₘ(PO₄)₃ wherein 0<m<1, preferably wherein 0.2<m<0.8, more preferably wherein 0.3<m<0.5. According to the invention, m as referred to herein, is measured by Scanning Electron Microscopy with Energy Dispersive X-Ray (SEM-EDX) analysis.

The ceramic oxide electrolyte material preferably consists of LATP and/or LAGP as described herein, which has optionally been doped, most preferably consists of LATP which has optionally been doped. In some embodiments the LATP and/or LAGP has optionally been doped with a dopant selected from the group consisting of tantalum, niobium, allium, indium, tin, antimony, bismuth, yttrium, germanium, calcium. strontium, barium, hafnium, or combinations thereof. If doped, the dopant is typically present in an amount of less than 2 wt. % (by total weight of LATP and/or LAGP), preferably less than 1 wt. % (by total weight of LATP and/or LAGP). In embodiments wherein the ceramic oxide electrolyte material consists of LATP and/or LAGP as described herein, which has optionally been doped, it is preferred that the solid composite cathode composition does not comprise further oxide materials aside from the electrode active material.

As will be understood by the skilled person, the electrode active material comprising Li, M, and O discussed herein is cathode active material which is also referred to as positive electrode active material. The cathode polarity can be positive or negativity depending on the mode of operation of the electrochemical cell comprising the electrode active material. The electrode active material preferably comprises Li, M, and O, wherein M comprises 30
Ni in a content x, wherein 55.0 mol %≤x≤95.0 mol %, relative to M;
Mn in a content y, wherein 0.0 mol %≤y≤40.0 mol %, relative to M;
Co in a content z, wherein 0.0 mol %≤z≤40.0 mol %, relative to M;
D in a content a, wherein 0.0 mol %≤a≤2.0 mol %, relative to M, wherein D is at least one element other than Li, Ni, Mn, Co, and O;
wherein x+y+z+a is 100.0 mol %;
preferably wherein M comprises:
Ni in a content x, wherein 55.0 mol %≤x≤80.0 mol %, relative to M;
Mn in a content y, wherein 10.0 mol %≤y≤30.0 mol %, relative to M;
Co in a content z, wherein 10.0 mol %≤z≤30.0 mol %, relative to M;
D in a content a, wherein 0.0 mol %≤a≤2.0 mol %, relative to M, wherein D is at least one element other than Li, Ni, Mn, Co, and O;
wherein x+y+z+a is 100.0 mol %;
more preferably
wherein M comprises:
Ni in a content x, wherein 55.0 mol %≤x≤70.0 mol %, relative to M;
Mn in a content y, wherein 15.0 mol %≤y≤25.0 mol %, relative to M;
Co in a content z, wherein 15.0 mol %≤z≤25.0 mol %, relative to M;
D in a content a, wherein 0.0 mol %≤a≤2.0 mol %, relative to M, wherein D is at least one element other than Li, Ni, Mn, Co, and O;
wherein x+y+z+a is 100.0 mol %.

In some particularly preferred embodiments, x is about 60 mol %, y is about 20 mol % and z is about 20 mol %.

In some particularly preferred embodiments a=0.0 mol %.

According to the invention, x, y, z, and a as referred to herein, are measured by Inductively coupled plasma-optical emission spectrometry (ICP-OES).

In particularly preferred embodiments, the electrode active material described herein is the only electrode active material comprised in the composite cathode material of the present invention.

It is particularly preferred that the enhancing agent comprises lithium fluoride (LiF). As is shown in the appended examples, exceptional electrochemical results have been obtained with the selected electrolyte material and electrode active material in combination with LiF before and after sintering. In preferred embodiment of the invention, the enhancing agent is LiX wherein X is a halide and wherein more than at least 50 mol % of X represents F, preferably at least 80 mol % of X represents F, most preferably X represents F (such that the enhancing agent consists of lithium fluoride (LiF)).

Typically, the enhancing agent is present in an amount of at least 0.5 wt. % (by total weight of the composition). For example, the enhancing agent may be present in an amount of at least 0.8 wt. % (by total weight of the composition), at least 1.2 wt. % (by total weight of the composition), or at least 1.5 wt. % (by total weight of the composition). As has been shown in the appended examples, even at these low concentrations the enhancing agent already significantly enhances the electrochemical characteristics before and after sintering. The present inventors have found that the enhancing agent surprisingly shows a significant further increase in beneficial effects when used at high rates. Hence, in accordance with preferred embodiments of the invention, the enhancing agent is present in an amount of at least 4 wt. % (by total weight of the composition), preferably at least 4.5 wt. % (by total weight of the composition). In accordance with highly preferred embodiments of the invention, the enhancing agent is present in an amount of at least 7 wt. %, more preferably at least 8 wt. % (by total weight of the composition). The enhancing agent is preferably present in an amount of less than 25 wt. % (by total weight of the composition), preferably less than 20 wt. % (by total weight of the composition), most preferably less than 14 wt. % (by total weight of the composition).

In preferred embodiments of the invention, the ratio (w/w) of the electrode active material to the ceramic oxide electrolyte material is at least 1:1, preferably at least 1.5:1, more preferably at least 1.8:1, most preferably at least 2:1. The ratio is preferably less than 8:1, preferably less than 6:1, more preferably less than 3:1, most preferably less than 2.5:1.

An optional but highly preferred additional component of the composite cathode material of the invention is a conductivity aid, in particular a carbon-based conductivity aid. The present inventors have found that carbon-based conductivity aids exhibit significant oxidation (and associated functionality loss) when a composite cathode composition containing such carbon-based conductivity aid is sintered. The formulations comprising an enhancing agent according to the present invention overcome such issues as they allow sintering at low temperature thereby limiting the reactivity between the components, including carbon oxidation. The carbon-based conductivity aid may be any carbon-rich material, such as any material comprising at least 95 wt. % carbon, preferably any material comprising at least 99 wt. % carbon. Examples of suitable materials are graphite, carbon black, carbon fibres, carbon nanotubes, graphene and combinations thereof. A highly preferred carbon-based conductivity aid which the inventors have found to exhibit improved electrochemical performance compared to other carbon-based conductivity aids when employed in the solid composite cathode compositions of the present invention is carbon black. Carbon black is known to the skilled person and includes variants such as acetylene black or super C65.

In preferred embodiments, the carbon-based conductivity aid as described herein is present in the solid composite cathode composition of the present invention in an amount of at least 0.5 wt. % (by combined weight of the ceramic oxide electrolyte material and the electrode active material), preferably at least 1 wt. % (by combined weight of the ceramic oxide electrolyte material and the electrode active material), more preferably at least 3 wt. % (by combined weight of the ceramic oxide electrolyte material and the electrode active material). Typically, the carbon-based conductivity aid is present in an amount of less than 12 wt. % (by combined weight of the ceramic oxide electrolyte material and the electrode active material), preferably less than 9 wt. % (by combined weight of the ceramic oxide electrolyte material and the electrode active material), more preferably less than 7 wt. % (by combined weight of the ceramic oxide electrolyte material and the electrode active material).

In general, it is preferred that the combined amount of the ceramic oxide electrolyte material, the electrode active material, the enhancing agent and optional carbon-based conductivity aid is at least 90 wt. % (by total weight of the composition), preferably at least 95 wt. % (by total weight of the composition), more preferably at least 98 wt. % (by total weight of the composition). In some embodiments, the solid composite cathode composition consists essentially of the ceramic oxide electrolyte material, the electrode active material, the enhancing agent and optional carbon-based conductivity aid.

In highly preferred embodiments of the invention, the solid composite cathode composition has been sintered. In particularly preferred embodiments, the material has been sintered at a temperature of less than 600° C., preferably less than 500° C., more preferably less than 450° C. In particularly preferred embodiments, the material has been sintered at a temperature of more than 200° C., preferably more than 300° C., more preferably more than 350° C. In particularly preferred embodiments, the material has been sintered at a temperature in the range of 200° C.-600° C., preferably in the range of 300° C.-500° C., more preferably in the range of 350° C.-450° C. The total time the material was submitted to a temperature above 200° C. is preferably within the range of 5 minutes to 48 hours, preferably within the range of 10 minutes to 24 hours, more preferably within the range of 30 minutes to 10 hours. Sintering was optionally performed while submitting the material to elevated pressure, for example a pressure of at least 0.1 GPa or at least 0.5 GPa. In some embodiments sintering was performed while submitting the material to elevated pressure within the range of 1-5, GPa, preferably 1-3 GPa, in order to achieve high compaction while avoiding grain splitting. In any of the embodiments described herein, it is preferred that the solid composite cathode composition has been sintered under inert atmosphere or air, preferably air. Without wishing to be bound by any theory, in view of the deterioration of the material at elevated sintering temperatures, the present inventors believe that the temperature and duration at which a composition was submitted to sintering could be derived from the end product by constructing temperature-time calibration curves at different temperatures and sampling different timepoints for each curve to determine the associated X-ray diffraction spectra of the material at different temperatures and durations and comparing the X-ray diffraction spectrum of a material to be analyzed with the X-ray diffraction spectra recorded for the calibration curves.

The solid composite cathode compositions provided herein are preferably provided having a ratio A of less than 2.3
wherein

$$A = ( D {C}_{C / 20} ) / ( D {C}_{1 C} )$$

wherein the ratio A is determined on a coin cell by performing five full discharge cycles at each C-rate of C/20, C/10, C/5, C/2, and 1C, performed consecutively in this order,
and DC_{C/20} is the first discharge capacity expressed in mAh/g determined at a C-rate of C/20,
and DC_{1C} is the first discharge capacity expressed in mAh/g determined at a C-rate of 1C. The ratio A is preferably within the range of 1.5-2.5, more preferably within the range of 1.5-2.2, most preferably within the range of 1.5-1.9. The ratio A is preferably determined on a coin cell immediately after assembly (without aging), preferably at 2.7-4.3 V, preferably at 2.9-3.1 V, for example using a TOYO battery cycler. The ratio A is preferably determined on coin cells prepared by mixing the solid cathode composition with polyvinylidene fluoride (PVDF) in a ratio of 90:10 that gives a total weight of 400 mg in 1.4-1.6 mL N-Methyl-2-pyrrolidone solvent (NMP) solvent, tape casting the resulting slurries on aluminium foils with a wet thickness of 300 μm using a doctor blade and drying the laminates overnight at 80° C. under dynamic vacuum, followed by punching dried laminates in to disks having diameters chosen in such a way the areal capacity (mAh/cm²) remains in the range of 0.3-0.45 mAh/cm², with composite cathode material loading corresponding to 2-3 mg/cm² and densifying disks with a uniaxial pressure of 0.1-0.3 MPa and drying at 120° C. overnight before cell assembly with lithium metal anode and LiPF₆ 1M in EC-DMC (ethylene carbonate:dimethyl carbonate 3:7) as electrolyte.

In another aspect of the invention there is provided a method for preparing a composite cathode composition, preferably for preparing the composition as described herein earlier, comprising the steps of:
a) providing at least the following precursors:
   a ceramic oxide material comprising lithium aluminium titanium phosphate (LATP) and/or lithium aluminium germanium phosphate (LAGP);
   an electrode active material comprising Li, M, and O, wherein M comprises Ni and one or both of Mn and Co;
   an enhancing agent which is LiX wherein X is a halide; and
   optionally a carbon-based conductivity aid;
b) preparing a substantially homogenous mixture comprising the precursors provided in step (a); and
c) optionally subjecting the mixture of step (b) to sintering.

The preferred embodiments of the composite cathode composition, in particular of the identity and (relative) amounts of the ceramic oxide material, the electrode active material, the enhancing agent and the carbon-based conductivity aid as explained herein in the context of the composite cathode composition, are equally applicable to the method for preparing the composite cathode composition described herein.

Step (b) is preferably a dry blending step and may take place using any suitable means known to the skilled person, such as simple pestle and mortar, ribbon mixers, rotary drums, ploughshare mixers, paddle mixers, conical screw mixers, etc. Step (b) may also comprise a size reduction or comminution of one or more of the precursors provided in step (a), for example using ball milling, hammer milling, pin milling, etc.

Step (b) may comprise a first step of mixing a subset of the precursors provided in step (a), followed by addition of the remaining precursors provided in step (a).

Step (c) preferably comprises sintering at a temperature of less than 600° C., preferably less than 500° C., more preferably less than 450° C. In particularly preferred embodiments, the material has been sintered at a temperature of more than 200° C., preferably more than 300° C., more preferably more than 350° C. In particularly preferred embodiments, the material has been sintered at a temperature in the range of 200° C.-600° C., preferably in the range of 300° C.-500° C., more preferably in the range of 350° C.-450° C. The total time the material is submitted to a temperature above 200° C. is preferably within the range of 5 minutes to 48 hours, preferably within the range of 10 minutes to 24 hours, more preferably within the range of 30 minutes to 10 hours. Sintering is optionally performed while submitting the material to elevated pressure, for example a pressure of at least 0.1 GPa or at least 0.5 GPa. In some embodiments sintering is performed while submitting the material to elevated pressure within the range of 1-3 GPa, preferably 1-5 GPa, in order to ensure sufficient compaction while avoiding grain splitting.

In another aspect of the invention there is provided an electrode comprising the solid composite cathode material of the present invention. In particularly preferred embodiments of the invention, the electrode comprises the solid composite cathode material of the present invention in combination with a binder, such as a polymer binder. The binder is not particularly limiting and can be any suitable polymer binder, such as polyimide (PI), polyvinylidene chloride (PVdC), polyethylene oxide (PEO), polyvinylidene fluoride (PVdF) and the like.

In another aspect of the invention there is provided an electrochemical cell comprising the solid composite cathode material as described herein.

In another aspect of the invention, there is provided the use of the solid composite cathode material as described herein as a cathode for an electrochemical cell.

In another aspect of the invention, there is provided a battery, more specifically a lithium-ion battery or a lithium metal battery comprising at least one electrochemical cell comprising the solid composite cathode material as described herein, for example two or more electrochemical cells according to the invention.

In another aspect of the invention, there is provided a method of making or operating cars, computers, personal digital assistants, mobile telephones, watches, camcorders, digital cameras, thermometers, calculators, laptop BIOS, communication equipment, remote car locks, and stationary applications such as energy storage devices for power plants by employing at least one battery or at least one electrochemical cell comprising the solid composite cathode material as described herein.

In another aspect of the invention, there is provided the use of the electrochemical cell comprising the solid composite cathode material of the invention in motor vehicles, bicycles operated by electric motor, robots, aircraft (for example unmanned aerial vehicles including drones), ships satellites, or stationary energy stores.

In another aspect of the invention, there is provided the use of lithium halide for improving the electrochemical properties, such as the cycling performance, of an electrochemical cell comprising a composite cathode material, said composite cathode material a ceramic oxide electrolyte material comprising lithium aluminium titanium phosphate (LATP) and/or lithium aluminium germanium phosphate (LAGP); an electrode active material comprising Li, M, and O, wherein M comprises Ni and one or both of Mn and Co; and optionally a carbon-based conductivity aid. The preferred embodiments of the composite cathode composition, in particular of the identity and (relative) amounts of the ceramic oxide material, the electrode active material, the enhancing agent and the carbon-based conductivity aid as explained herein in the context of the composite cathode composition, are equally applicable to the use of lithium halide described herein.

### EXAMPLES

### I. Preparation of Composite Cathode Materials

Composite cathode materials according to the invention were prepared in batches of 2 g using the following starting products in the following order: NMC (LiNi_{0.6}Mn_{0.2}Co_{0.2}O₂ according to manufacturer spec), LiF (99.98% (metal basis)), carbon black (acetylene black−KetjenBlack®) and LATP (Li₁₊ₘAlₘTi₂₋ₘ(PO₄)₃ wherein 0.3<m<0.5 according to SEM-EDX). In a glovebox (O₂<1 ppm and H₂O<1 ppm), appropriate amounts of starting materials were weighed and mixed using agate mortar and pestle. Composites were taken to the heat treatments in GAF (Muffle) furnace under controlled atmosphere, which was pre-calibrated under similar heating conditions. Samples were heated with a heating rate of 1° C./min followed by a dwelling of 1 hour at the sintering temperature (without elevated pressure) and cooled back to room temperatures. All the samples were heated in a 30 mL alumina (Al₂O₃) crucible with open lid. The transfer time of samples between glovebox and furnace was controlled in order to avoid exposure to ambient conditions. Also, after the heat treatments, samples were transferred to the glovebox at a temperature range of 120-150° C. to avoid moisture absorption.

Control materials were prepared in the same manner but without LiF.

The NMC, LATP and carbon black were always used in a ratio (w/w) of 65:30:05 respectively. The LiF was added in an amount of 0, 2, 5 and 10 wt. % (based on combined weight of NMC, LATP and carbon black). In other words, LiF was added at a ratio (w/w) (LiF):(NMC+LATP+carbon black) of 0:100; 2:100; 5:100 and 10:100 respectively as is shown in the below table. Virgin NMC (unsintered, pure) was also used as a reference for X-ray diffraction spectra.

| | NMC | LATP | Carbon black | LiF | Sintered |
|---|---|---|---|---|---|
| | (weight | (weight | (weight | (weight | (temp in |
| | parts) | parts) | parts) | parts) | ° C.) |
| Comparative | 65 | 30 | 5 | 0 | No |
| example 1 | | | | | |
| Comparative | 65 | 30 | 5 | 0 | Yes (400) |
| example 2 | | | | | |
| Comparative | 65 | 30 | 5 | 0 | Yes (470) |
| example 3 | | | | | |
| Comparative | 65 | 30 | 5 | 0 | Yes (500) |
| example 4 | | | | | |
| Example 5 | 65 | 30 | 5 | 2 | No |
| Example 6 | 65 | 30 | 5 | 5 | No |
| Example 7 | 65 | 30 | 5 | 10 | No |
| Example 8 | 65 | 30 | 5 | 2 | Yes (400) |
| Example 9 | 65 | 30 | 5 | 5 | Yes (400) |
| Example 10 | 65 | 30 | 5 | 10 | Yes (400) |

### II. Preparation of Electrodes

Slurries of the composite cathode material of comparative examples 1-4 and examples 5-10 with polyvinylidene fluoride (PVDF) in a ratio of 90:10 in 1.4-1.6 ml N-Methyl-2-pyrrolidone solvent (NMP) solvent were prepared in quantities of 400 mg. PVDF was dissolved in NMP solvent using a magnetic stirrer for 2 hours after which the composite cathode material was added and stirring continued overnight. Slurries were tape casted on aluminium foils with a wet thickness of 300 μm using a doctor blade. Laminates were dried overnight at 80° C. under dynamic vacuum. Dried laminates were punched in to disks and diameters were chosen in such a way the areal capacity (mAh/cm²) remains in the range of 0.3-0.45 mAh/cm², with cathode active material loading corresponding to 2-3 mg/cm². Disks were densified with a uniaxial pressure of 0.1-0.3 MPa and dried at 120° C. overnight before cell assembly. All the processes were carried out in dry room (dew point approx. 37° C.).

### III. Determination of Electrochemical Characteristics

2032-coin cells were assembled with the composite cathode disks prepared as described in the previous section, lithium metal anode and LiPF₆ 1M in EC-DMC (ethylene carbonate:dimethyl carbonate 3:7) as electrolyte. Coin cells were galvanostatically charged-discharged immediately after the cell assembly (without aging) between 2.7-4.3 V along with cycling performance tests using TOYO battery cycler.

The cycling protocol consisted of 5 cycles each at C-rates C/20, C/10, C/5, C/2, 1C followed by 100 cycles at C/10. Capacity values are normalized with respect to the weight of active material (NMC) and results were verified with reproducibility. Glass fiber was used as the separator.

### IV. Determination of X-Ray Diffraction Spectra

XRD measurements were carried out with a BRUKER D8 Endeavor X Ray Diffractometer equipped with LYNXEYE XE-T detector using Co radiation (λ:Kα1=1.78897 Å, Kα2=1.79285 Å). Samples were measured in a 20 range of 10°-130° with a step size of 0.016° and a total time of 19.20 seconds/step. Silicon holders were used in order to avoid the amorphous background from normal holders due to the limited quantity of samples. Comparison of peaks were obtained after background subtraction and Kα2 stripping (to avoid the doublets arising from non-monochromatic source). The peaks considered for comparison were (101), (012), (006) and (104) from NMC around which the crystal structure transitions were observed. Intensities were normalized to (104) peaks of NMC at 20=52°.

### V. Results

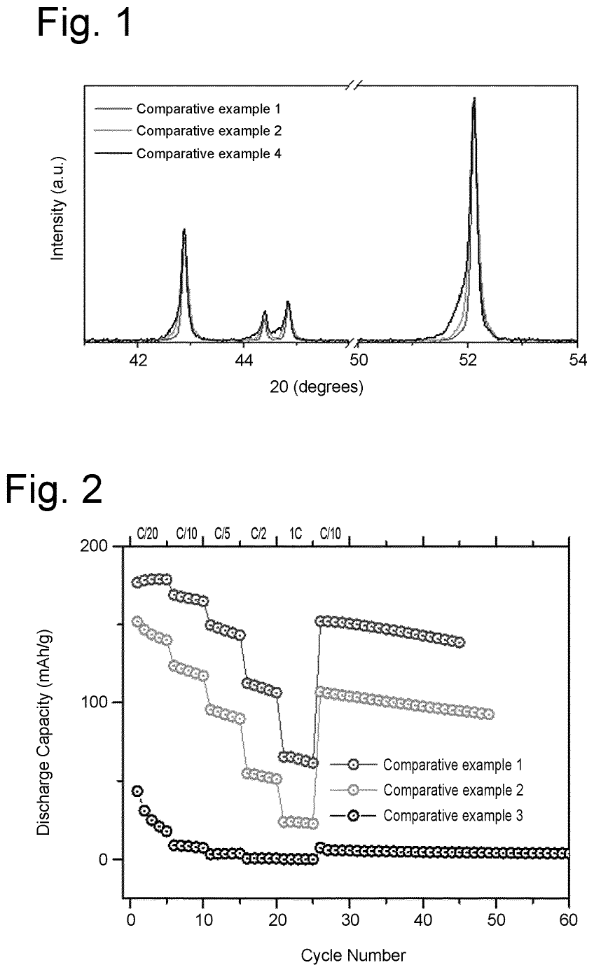

FIG. 1 shows the temperature-dependent degradation of NMC-LATP mixtures as evidenced by the XRD spectrum of comparative examples 2 and 4. It can be observed that the composite cathode material of comparative example 4 (treated at 500° C.) shows significant deterioration.

FIG. 2 shows the temperature-dependent deterioration of cycling performance of NMC-LATP mixtures of comparative examples 1-3. It can be observed that the composite cathode material of comparative example 2 (treated at 400° C.) already has significantly diminished performance, while the composite cathode material of comparative example 3 (treated at 470° C.) is no longer functional.

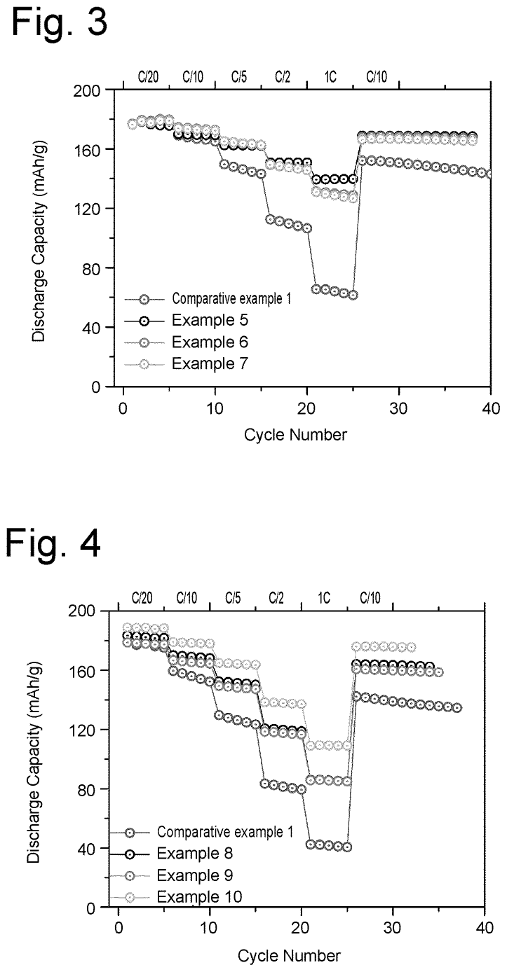

FIG. 3 shows the enhancing effect of lithium fluoride addition on the electrochemical performance of the composite cathode materials of examples 5-7 as compared to comparative example 1. The electrochemical performance is enhanced even before sintering and is particularly enhanced at high C-rates.

FIG. 4 shows the enhancing effect of lithium fluoride addition on the electrochemical performance of the composite cathode materials of examples 8-10 as compared to comparative example 2. The electrochemical performance is particularly enhanced at high C-rates and at high LiF loading.

1-15. (canceled)

16. A solid composite cathode composition comprising:
a ceramic oxide electrolyte material comprising lithium aluminum titanium phosphate (LATP) and/or lithium aluminum germanium phosphate (LAGP);
an electrode active material comprising Li, M, and O, wherein M comprises Ni and one or both of Mn and Co; and
an enhancing agent, which is LiX, wherein X is a halide.

17. The composition according to claim 16, wherein the ceramic oxide electrolyte material comprises LATP of formula Li₁₊ₘAlₘTi₂₋ₘ(PO₄)₃ wherein 0<m<1.

18. The composition, according to claim 16, wherein the electrode active material comprises Li, M, and O, wherein M comprises
Ni in a content x, wherein 55.0 mol %≤x≤95.0 mol %, relative to M;
Mn in a content y, wherein 0.0 mol %≤y≤40.0 mol %, relative to M;
Co in a content z, wherein 0.0 mol %≤z≤40.0 mol %, relative to M; and
D in a content a, wherein 0.0 mol %≤a≤2.0 mol %, relative to M, wherein D is at least one element other than Li, Ni, Mn, Co, and O;
wherein x+y+z+a is 100.0 mol %.

19. The composition, according to claim 16, wherein the enhancing agent is lithium fluoride.

20. The composition according to claim 16, wherein the enhancing agent is present in an amount of at least 0.5 wt. % (by total weight of the composition).

21. The composition according to claim 16, wherein the ratio (w/w) of the electrode active material to the ceramic oxide electrolyte material is at least 1:1.

22. The composition according to claim 16, wherein the solid further comprises a carbon-based conductivity aid.

23. The composition, according to claim 22, wherein the carbon-based conductivity aid is selected from the group consisting of graphite, carbon black, carbon fibers, carbon nanotubes, graphene, and combinations thereof.

24. The composition, according to claim 22, comprising at least 0.5 wt. % (by combined weight of the ceramic oxide electrolyte material and the electrode active material) of the carbon-based conductivity aid.

25. The composition, according to claim 16, wherein the combined amount of the ceramic oxide electrolyte material, the electrode active material, the enhancing agent, and optional carbon-based conductivity aid is at least 90 wt. % (by total weight of the composition).

26. The composition, according to claim 16, wherein the enhancing agent is distributed substantially homogeneously throughout the composition.

27. The composition, according to claim 16, which has been sintered.

28. A method for preparing a composite cathode composition, comprising the steps of:
a) providing at least the following precursors:
a ceramic oxide material comprising lithium aluminum titanium phosphate (LATP) and/or lithium aluminum germanium phosphate (LAGP);
an electrode active material comprising Li, M, and O, wherein M comprises Ni and one or both of Mn and Co;
an enhancing agent, which is LiX wherein X is a halide; and
optionally a carbon-based conductivity aid;
b) preparing a substantially homogenous mixture comprising the precursors provided in step (a); and
c) optionally subjecting the mixture of step (b) to sintering.

29. The method of claim 28, wherein step (c) is performed and wherein the temperature during the sintering of step (c) is less than 500° C.

30. An electrochemical cell comprising the solid material of claim 16.
